(19) United States
(12) Patent Application Publication
(10) Pub. No.: US 2009/0078551 A1
(43) Pub. Date: Mar. 26, 2009

(54) Rotary input apparatus

(75) Inventor: Eung-Cheon Kang, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,219

(22) Filed: Apr. 11, 2008

(30) Foreign Application Priority Data
Sep. 20, 2007 (KR) 10-2007-0095659

(51) Int. Cl. H01H 3/08

(52) U.S. Cl. 200/336

(57) ABSTRACT

A rotary input apparatus is disclosed. The rotary input apparatus may include a wheel, a cover having a center hole that exposes the wheel to the exterior, and a sheet interposed between the wheel and the cover, where the wheel may include a flange portion formed on a periphery of the wheel. A holding groove may be formed in the flange portion, and a protrusion protruding upwards may be formed on the flange portion. The cover may include an insertion portion formed on a periphery of the center hole. The insertion portion may protrude downwards and may be placed in the holding groove. The sheet may be in contact with both the protrusion and the insertion portion. This rotary input apparatus can stop foreign substances from infiltrating the interior of the rotary input apparatus.

### CROSS-REFERENCE TO RELATED APPLICATIONS

This application claims the benefit of Korean Patent Application No. 10-2007-0095659 filed with the Korean Intellectual Property Office on Sep. 20, 2007, the disclosure of which is incorporated herein by reference in its entirety.

### BACKGROUND

1. Technical Field

The present invention relates to a rotary input apparatus.

2. Description of the Related Art

In general, a mobile terminal has the numbers 0-9 and the symbols * and # on a keypad of 12 keys. In addition to the numbers, there may also be alphabet letters as well as consonants and vowels of other local languages marked on such a keypad, to enable the input of information including numbers and letters. Recently, navigation tools formed above the keypad are being used, which are associated with a variety of functions such as phone number search, writing and managing text messages, and connecting to the Internet, etc. There are various forms of navigation tools, such as button types and rotary types, etc., but with the recent popularization of the wireless Internet, the use of the rotary type input apparatus is increasing, as it enables various functions such as menu browsing and web page search, etc.

Rotary input apparatus may also be used in televisions, camcorders, and PDA's (personal digital assistants), etc., in the form of rotary switches, rotary encoders, and rotary volume dials, etc. The use of the rotary type input apparatus has extended to various fields, including portable MP3 players and optical inputting devices such as mice, etc., to provide greater convenience and a wider variety of inputting methods.

With the increase in use of the rotary input apparatus, however, several problems have occurred. One such problem is that if foreign substances, such as water and dust, enter into the gap between the wheel and the cover, the rotary input apparatus may malfunction or fail to operate.

### SUMMARY

An aspect of the invention is to provide a rotary input apparatus that can prevent the infiltration of foreign substances.

A rotary input apparatus according to one aspect of the invention includes a wheel, a cover having a center hole that exposes the wheel to the exterior, and a sheet interposed between the wheel and the cover, where the wheel includes a flange portion formed on a periphery of the wheel. A holding groove is formed in the flange portion, and a protrusion protruding upwards is formed on the flange portion. The cover includes an insertion portion formed on a periphery of the center hole. The insertion portion protrudes downwards and is placed in the holding groove. The sheet is in contact with both the protrusion and the insertion portion.

A rotary input apparatus according to another aspect of the invention includes a wheel and a cover having a center hole that exposes the wheel to the exterior. Here, the wheel includes a flange portion formed on a periphery of the wheel, where a holding groove is formed in the flange portion. The cover includes an insertion portion formed on a periphery of the center hole, where the insertion portion protrudes downwards and is placed in the holding groove. The insertion portion is positioned with a predetermined gap from an inner surface of the holding groove.

Embodiments of the rotary input apparatus according to a certain aspect of the invention may include one or more of the following features. For example, the flange portion can include a horizontal portion, which may protrude horizontally from the periphery of the wheel, and a vertical portion, which may protrude from one end of the horizontal portion, where the holding groove may be formed by the horizontal portion and the vertical portion. The protrusion can be formed on the horizontal portion, and can be formed to have a triangular cross section.

The insertion portion may include a contact portion that is in contact with the sheet, where the contact portion can be formed in a more outward position than the protrusion from a middle of the center hole. The sheet may be such that has a flexible quality, and may be formed from Teflon or polyethylene terephthalate.

The cover can include a circular guide groove, with a part of the vertical portion positioned in the guide groove. The wheel can include a through-hole formed in the center, which may having a ring-shaped protruding portion formed on its inner perimeter, and a center key can be inserted in the through-hole, while the center key can have a detent portion that is inserted onto the ring-shaped protruding portion.

The center key may include a securing protrusion that protrudes downwards, with the securing protrusion inserted into a circuit board. The center key may also include a center protrusion protruding downwards, which is configured to press a center button equipped on the circuit board. The wheel can include an insertion cavity, in which a wheel securing member may be inserted, where the wheel securing member may be secured to a circuit board.

The wheel securing member may include an insertion portion inserted into the insertion cavity and a wheel securing protrusion secured to the circuit board. The insertion portion can include a securing member protrusion protruding downwards, which may be configured to press a side button formed on the circuit board. Also, the wheel may include multiple detent protrusions that protrude downwards, where the detent protrusions may be inserted through a washer, and the washer may be caught on the wheel securing member.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a rotary input apparatus according to an embodiment of the present invention.

FIG. 2A is a plan view of a rotary input apparatus according to an embodiment of the present invention.

FIG. 2B is a cross-sectional view across line AA′ of FIG. 2A.

FIG. 2C is a bottom view of a rotary input apparatus according to an embodiment of the present invention.

FIG. 3 is a cross-sectional view of a wheel securing member in a rotary input apparatus according to an embodiment of the present invention.

FIG. 4A is a plan view of a center key in a rotary input apparatus according to an embodiment of the present invention.

FIG. 4B is a cross-sectional view across line BB′ of FIG. 4A.

FIG. 4C is a bottom view of a center key in a rotary input apparatus according to an embodiment of the present invention.

FIG. 5 is a perspective view of a washer in a rotary input apparatus according to an embodiment of the present invention.

FIG. 6 is a cross-sectional view of a rotary input apparatus according to an embodiment of the present invention, when one side of the wheel is pressed.

FIG. 7 is a cross-sectional view of a flange portion and an insertion portion in a rotary input apparatus according to another embodiment of the present invention.

FIG. 8 is a cross-sectional view of a rotary input apparatus according to yet another embodiment of the present invention.

### DETAILED DESCRIPTION

As the invention allows for various changes and numerous embodiments, certain embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

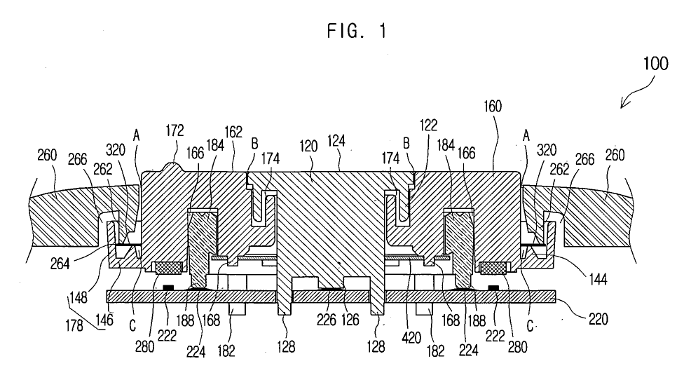

FIG. 1 is a cross-sectional view of a rotary input apparatus according to an embodiment of the present invention.

Referring to FIG. 1, a rotary input apparatus 100 according to an embodiment of the invention may include a center key 120, of which the upper surface 124 may be exposed to the exterior, a wheel 160, of which the rim surface 162 may be exposed to the exterior, and a cover 260, which may be positioned on a periphery of the wheel 160. The wheel 160 can be secured to a circuit board 220 by a wheel securing member 180. The wheel 160 can be inserted through a washer 420, where the washer 420 can be caught onto the wheel securing member 180. A center button 226 and side buttons 224 may be equipped on the circuit board 220, which may be pressed by the center key 120 or the wheel securing member 180.

A magnet 280 may be secured to the reverse side of the wheel 160, and a detection element 222 may be secured to the circuit board 220 that detects changes in the magnetic field to allow the input of information. Thus, when the wheel 160 is rotated, there may be a change in the magnetic field generated by the magnet 280, which can be recognized by the detection element 222, so that information can be inputted based on the rotation of the wheel 160.

A user can press the center key 120 to activate the center button 226 or press a particular direction of the wheel 160 to activate a side button 224. The user may also input certain information by rotating the wheel 160.

As such, the rotary input apparatus 100 according to an embodiment of the invention allows various ways to input information, including rotating the wheel 160, pressing the center button 226, and pressing the side buttons 224, making it possible to input various types of information in a more convenient manner.

The rotary input apparatus 100 can be used not only in a mobile terminal, such as a cell phone and PDA, etc., but also as an information inputting apparatus in a portable computer, MP3 player, game console, and optical mouse, etc. The rotary input apparatus 100 may also be installed on a remote control, etc., for a television or audio system, to perform functions for setting the volume or changing channels, etc.

A flange portion 178 may be formed on a periphery of the wheel 160, and a holding groove 142 of a particular depth may be formed in the flange portion 178. Inside the holding groove 142, there may be a protrusion 144 that may protrude in an upward direction. Also, the cover 260 may include an insertion portion 262 that may be inserted in the holding groove 142, while a sheet 320 may be placed between the protrusion 144 and the insertion portion 262.

Thus, if a foreign substance, such as water, infiltrates the rotary input apparatus 100 through the gap A formed between the wheel 160 and the cover 260, the foreign substance may be stopped primarily by the sheet 320. The foreign substance that passes through the sheet 320 may be retained in the portion C of the holding groove 142, and its infiltration may be stopped secondarily by the protrusion 144. If a foreign substance infiltrates the rotary input apparatus 100 through the gap B formed between the wheel 160 and the center key 120, the foreign substance may be kept in the groove formed by a ring-shaped protruding portion 174. As such, a rotary input apparatus 100 according to this embodiment can prevent the infiltration of foreign substances, and may thus prevent malfunctioning and reduce failures in the apparatus.

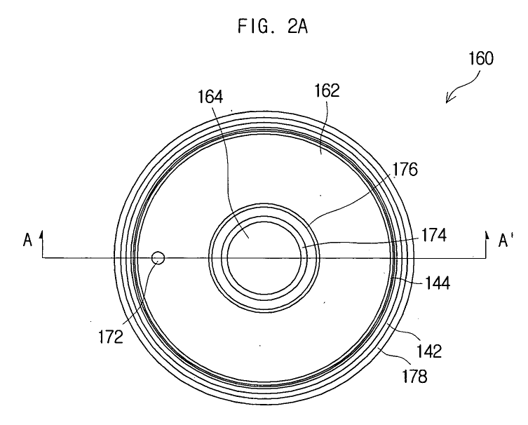

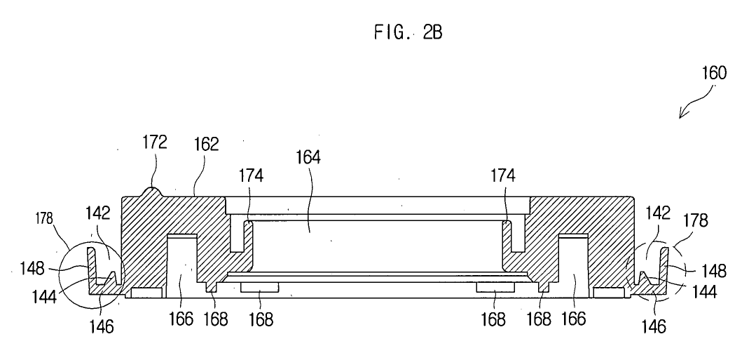

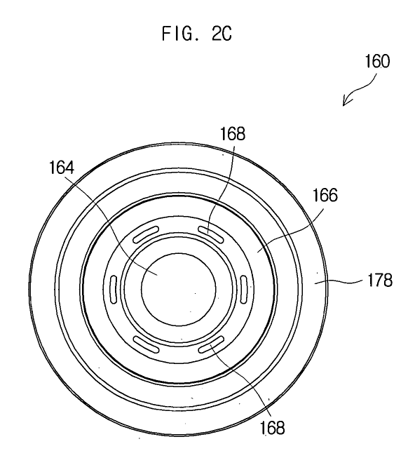

A description will now be provided on the composition and coupling relationships of a wheel 160 according to an embodiment of the invention, with reference to FIG. 1 and FIGS. 2A to 2C. FIG. 2A is a plan view of a rotary input apparatus according to an embodiment of the present invention, FIG. 2B is a cross-sectional view across line AA′ of FIG. 2A, and FIG. 2C is a bottom view of a rotary input apparatus according to an embodiment of the present invention.

Referring to FIGS. 2A to 2C, the wheel 160 may have a generally circular shape, and may have a through-hole 164 formed in the center, which can hold a center securing member 140. On the reverse side of the wheel 160, an insertion cavity 166 may be formed along a circumferential direction, with detent protrusions 168 protruding downwards from a periphery of the insertion cavity 166. A flange portion having a holding groove 142 may be formed on a periphery of the wheel 160.

Referring to FIG. 2A, a rim surface 162, on which a rotation protrusion 172 can be formed, may be exposed to the exterior. A user may touch the rotation protrusion 172 with the user's finger, etc., and apply a certain amount of force to rotate the wheel 160 clockwise or counter-clockwise. A wheel securing member 180 may rotatably support the wheel 160.

As illustrated in FIG. 1, a center key 120 may be inserted into the through-hole 164. In this way, the upper surface 124 of the center key 120 can be exposed to the exterior through the through-hole 164. The wheel 160 can be made to rotate about the through-hole 164, as the center key 120 inserted in the through-hole 164 may be inserted through the circuit board 220 and may not be rotated.

As illustrated in FIG. 2B, a ring-shaped protruding portion 174 may be formed on an inner perimeter of the through-hole 164. The ring-shaped protruding portion 174, as illustrated in FIG. 1, may receive the detent portion 122 of the center key 120, so that if a foreign substance enters through the gap B formed between the center key 120 and the wheel 160, the foreign substance may be retained in the space formed by the ring-shaped protruding portion 174. In this way, the ring-shaped protruding portion 174 may aid in stopping the infiltration of foreign substances.

On the reverse side of the wheel 160, an insertion cavity 166 may be formed in a circumferential direction. As illustrated in FIG. 1, an insertion portion 184 of the wheel securing member 180 can be rotatably inserted in the insertion cavity 166. Detent protrusions 168 may protrude downwards from a periphery of the insertion cavity 166. Multiple detent protrusions 168 can be used in certain intervals. The wheel securing member 180 inserted in the insertion cavity 166 can be prevented from being detached from the wheel securing member 180 by the washer 420 and the detent protrusions 168, which may be folded in a subsequent process. The ends of the detent protrusions 168 can be folded according to a process that may include inserting the wheel securing member 180 in the insertion cavity 166, inserting a washer 420 onto the detent protrusions 168, and then having the detent protrusions 168 face outwards by applying certain amounts of force and heat using a jig (not shown), etc.

Along the periphery of the wheel 160, a flange portion 178 may be formed, which holds an insertion portion 262 of the cover 260. The flange portion 178, as illustrated in FIG. 1 and FIG. 2B, can include a horizontal portion 146 and a vertical portion 148, to form a generally “L” shaped cross section. The horizontal portion 146 may protrude outwards from the periphery of the wheel 160 in a substantially horizontal direction, while the vertical portion 148 may protrude upwards from the end of the horizontal portion 146. The horizontal portion 146 and vertical portion 148, along with the outer perimeter of the wheel 160, may form the holding groove 142. A protrusion 144 having a triangular cross section can be formed on the horizontal portion 146. The protrusion 144 may be in contact with a sheet 320.

On the reverse side of the wheel 160, a magnet 280 may be attached along the periphery of the insertion cavity 166, as illustrated in FIG. 1. A magnetic field may be formed in the vicinity of the magnet 280, while a detection element 222 may be mounted on the circuit board 220 facing the magnet 280. With the rotation of the wheel 160, the magnet 280 may be rotated together, causing a change in the magnetic field in relation to the detection element 222. In this way, the detection element 222 may detect the rotation of the wheel 160, to allow the input of certain information. For example, rotating the wheel 160 in a clockwise direction can be set to scroll the screen on the display downwards, while a counter-clockwise rotation can be set to scroll the screen on the display upwards.

Multiple detection elements 222 can be mounted on the circuit board 220, to detect the rotation of the wheel 160 by way of changes in the magnetic field. The detection element 222 may be a Hall sensor, which is a silicon semiconductor that utilizes the effect of electromotive forces being generated when electrons experience the Lorentz force in a magnetic field such that their direction is curved. The Hall sensor may generate electromotive forces that are proportional to the rotation of the magnet 280 attached to the wheel 160, which may be transferred via the circuit board 220 to an external control unit (not shown).

Of course, the detection element 222 is not limited to a Hall sensor, and any element may be used that is capable of detecting the rotation of the magnet 280. For example, the detection element may be an MR (magneto-resistive) sensor or a GMR (giant magneto-resistive) sensor. An MR sensor or a GMR sensor is an element of which the resistance value is changed according to changes in the magnetic field, and utilizes the property that electromagnetic forces curve and elongate the carrier path in a solid to change the resistance. MR sensors and GMR sensors are small in size and provide high signal levels, and they have excellent sensitivity, which allows operation in low-level magnetic fields. MR sensors and GMR sensors also display superb characteristics in terms of temperature stability.

While this particular embodiment provides an example in which changes in the magnetic field of the magnet 280 is used to sense the rotation of the wheel 160, the invention is not thus limited, and it is to be appreciated that various compositions may be employed. For example, methods using image processing and methods of sensing changes in resistance or capacitance, etc., can be utilized to sense the rotation of the wheel 160.

In the method of using image processing, marks indicating brightness may alternately be adhered to the reverse side of the wheel 160. While the reverse side of the wheel 160 is irradiated with a light emitting diode (LED), an image sensor may sense the rotation of the marks, caused by the rotation of the wheel 160, to enable the input of information.

In the method of using changes in resistance, a conductive material and a non-conductive material may alternately be arranged along the periphery of the wheel 160. The difference in strength of the electric current, as the wheel 160 makes contact with the conductive material and the non-conductive material, may be recognized to enable the input of information. The method of using changes in capacitance may include detecting the change in capacitance of a capacitor located on the reverse side of the wheel 160, when a finger or a writing utensil of the user makes contact with the rim surface 162 of the wheel 160 and rotates along the wheel 160. When the capacitance is used as described above, the wheel 160 itself may not have to rotate.

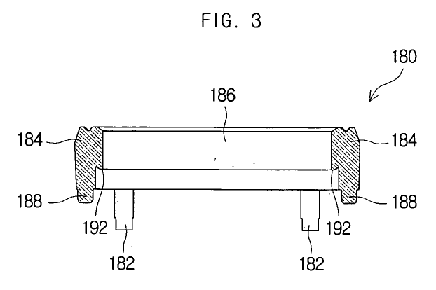

A description will now be provided on the composition and coupling relationships of a wheel securing member 180 according to an embodiment of the invention, with reference to FIG. 1 and FIG. 3. FIG. 3 is a cross-sectional view of a wheel securing member 180 according to an embodiment of the invention.

A wheel securing member 180 based on an embodiment of the invention may include a through-hole 186 formed in the center, an insertion portion 184 inserted in the insertion cavity 166 of the wheel 160, and wheel securing protrusions 182 protruding downward. The wheel securing member 180 may serve to rotatably support the wheel 160 while preventing the wheel 160 from being detached.

A part of the wheel 160 and the center key 120 may be positioned in through-hole 186 formed in the middle of the wheel securing member 180. As illustrated in FIG. 1, the insertion portion 184 of the wheel securing member 180 may be rotatably inserted in the insertion cavity 166 formed in the reverse side of the wheel 160. As illustrated in FIG. 1, securing member protrusions 188 may be in contact with the side buttons 224, and may serve to press the side buttons 224 when an external force is applied on the wheel 160.

Also, a step 192 may be formed along the periphery on the inner perimeter of the through-hole 186. As illustrated in FIG. 1, the washer, to which the wheel 160 is coupled, may be caught on the step 192. In this way, the wheel 160 with which the washer 420 is coupled can be prevented from becoming detached.

The wheel securing protrusions 182 protruding downwards from the wheel securing member 180, as illustrated in FIG. 1, can be inserted in and secured to the circuit board 220. Thus, the wheel securing member 180 can be secured to the circuit board 220 to rotatably support the wheel 160.

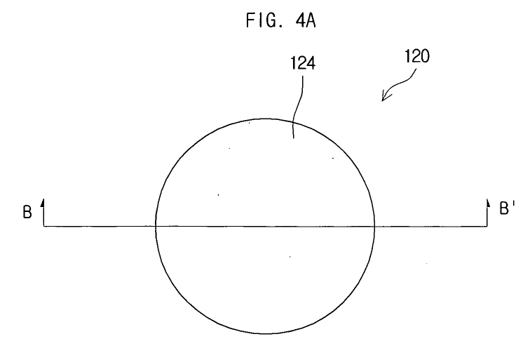

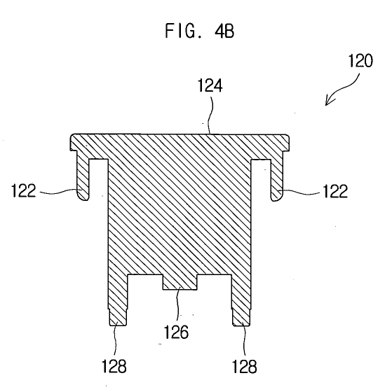

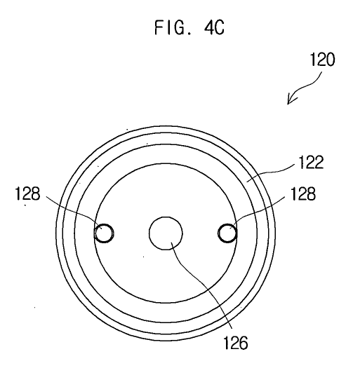

A description will now be provided on the composition and coupling relationships of a center key 120, with reference to FIG. 1 and FIGS. 4A to 4C. FIG. 4A is a plan view of a center key 120 in a rotary input apparatus 100 according to an embodiment of the present invention, FIG. 4B is a cross-sectional view across line BB′ of FIG. 4A, and FIG. 4C is a bottom view of the center key 120.

Referring to FIG. 1 and FIGS. 4A to 4C, a center key 120 based on an embodiment of the invention may have a circular upper surface 124 and a generally cylindrical shape. A detent portion 122 can be formed on the periphery of the center key 120, while a center protrusion 126 and securing protrusions 128 may be formed on the lower surface.

The upper surface 124 may be shaped as a circle, as illustrated in FIG. 1, and may be exposed to the exterior. A user may apply an external force on the upper surface 124, to press the center button 226.

The detent portion 122 can have a circular shape and can protrude downwards from below the upper surface 124 of the center key 120, such that the detent portion 122 forms a certain groove along the periphery of the center key 120. Referring to FIG. 1, the detent portion 122 may be inserted in the groove formed by the ring-shaped protruding portion 174 of the wheel 160, which can not only prevent the center key 120 from moving left and right, but also stop the flow of foreign substances that may enter through gap B.

As illustrated in FIG. 1, the center protrusion 126 protruding downwards from the lower surface of the center key 120 can be in contact with the center button 226. Thus, if an external force is applied on the upper surface 124 of the center key 120, the center key 120 may move downwards, causing the center protrusion 126 to press the center button 226 and initiate a particular function. When the external force applied on the center key 120 is removed, the center key 120 may move back upwards due to the elasticity of the center button 226 itself.

A description will now be provided on the center button 226 and side buttons 224 formed on the circuit board.

A center button 226 and side buttons 224 may be formed on the circuit board 220. The center button 226 can be pressed by the center protrusion 126 of the center key 120 to initiate a certain function, such as executing the selected menu item or connecting to the wireless Internet, etc. The side buttons 224 can be formed on the circuit board 220 facing the securing member protrusions 188 of the wheel securing member 180. In certain examples, there can be four side buttons 224 equipped in particular intervals. Of course, as mentioned above, it is apparent that the number and arrangement of the side buttons may vary as necessary. A side button 224 can be pressed by a securing member protrusion 188 to initiate a variety of functions. For example, four side buttons 224 can serve as movement buttons for the left, right, up, and down directions, and/or as short-cut keys for initiating any of a variety of functions, such as launching an MP3 player function, launching a text message service, connecting to the wireless Internet, and performing a phone number search, etc.

The center button 226 and side buttons 224 can be formed not only by dome buttons made of metal, but also by various other means, including pressure sensors and contact sensors, etc.

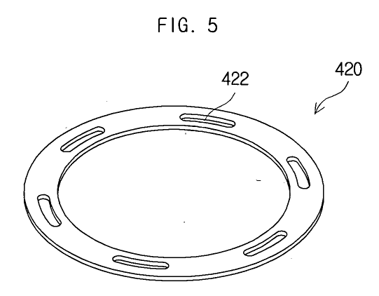

A description will now be provided on the composition and coupling relationships of a washer 420 according to an embodiment of the invention, with reference to FIG. 1 and FIG. 5.

Referring to FIG. 1 and FIG. 5, the washer 420 may have a donut-like shape, with multiple insertion holes 422 formed along the circumference. The detent protrusions 168 of the wheel 160 may be inserted through the insertion holes 422. The detent protrusions 168 inserted through the insertion holes 422 can be folded in a subsequent process, to prevent the wheel 160 and the washer 420 from being separated. The washer 420 in turn can be caught onto the step 192 of the wheel securing member 180 that may be secured to the circuit board 220, whereby the wheel 160 can be prevented from being detached from the wheel securing member 180.

The cover 260 may form the outer body of the rotary input apparatus 100 according to an embodiment of the invention, and may be formed as an integrated part of the case of an electronic product. The cover 260 may include a center hole that exposes the rim surface 162 of the wheel 160 to the exterior. As illustrated in FIG. 1, a downwardly-protruding insertion portion 262 can be formed along the periphery of the center hole.

A description will now be provided on the composition for stopping the infiltration of foreign substances in an input apparatus according to an embodiment of the invention, with reference to FIG. 1.

As illustrated in FIG. 1, a gap A may be formed between the wheel 160 and the cover 260, to allow the rotational and translational movement of the wheel 160. As such, foreign substances such as water and dust, etc., can enter into the rotary input apparatus 100 through gap A. Foreign substances that have thus entered into the rotary input apparatus 100 can cause malfunctions or failures in the rotary input apparatus 100. To resolve this problem, a rotary input apparatus 100 according to an embodiment of the invention may include a flange portion 178 formed around the wheel 160 and an insertion portion 262 formed on the cover 260, with a sheet 320 interposed between the flange portion 178 and the insertion portion 262.

The foreign substance that enters through gap A may first move onto the sheet 320. The sheet 320, as illustrated in FIG. 1, may have a width substantially the same as that of the holding groove 142, so that the foreign substance can be prevented from moving below the sheet 320. The insertion portion 262 of the cover 260 may be in contact with the sheet 320, the contact point 264 being further outwards compared to the protrusion 144. Therefore, even if there is a gap between the sheet 320 and the holding groove 142, so that the foreign substance moves below the sheet 320, the foreign substance can be blocked by the contact point 264 of the insertion portion 262 and the sheet 320, and the foreign substance may enter the inner portion C of the protrusion 144. The movement of the foreign substance that enters the inner portion C can be stopped by the protrusion 144 and the sheet 320, making it difficult for the foreign substance to move past the holding groove 142 towards the circuit board 220.

The guide groove 266 formed on the lower surface of the cover 260 may serve not only to guide the rotation of the vertical portion 148 of the flange portion 178, but also to allow a greater height for the vertical portion 148 and a greater depth for the holding groove 142. The greater the depth of the holding groove 142, the greater the likelihood that the foreign substance entering the holding groove 142 is stopped from entering into the input apparatus 100.

Also, as illustrated in FIG. 1, a gap B may be formed between the center key 120 and the wheel 160, to allow the up and down movement of the center key 120. As such, foreign substances such as water and dust, etc., can enter into the rotary input apparatus 100 through gap B. Foreign substances that have thus entered into the rotary input apparatus 100 can cause malfunctions or failures in the rotary input apparatus 100. To resolve this problem, a rotary input apparatus 100 according to an embodiment of the invention may include a ring-shaped protruding portion 174 formed on the wheel 160. The ring-shaped protruding portion 174 can form a groove that retains the foreign substance infiltrated through gap B, whereby the foreign substance can be stopped from moving to the interior of the input apparatus 100, especially the circuit board 220.

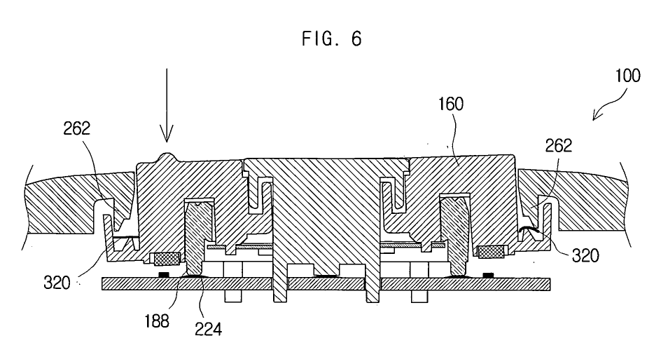

FIG. 6 is a cross-sectional view of the rotary input apparatus 100 illustrated in FIG. 1, when a part of the wheel 160 is pressed such that the wheel 160 is tilted.

Referring to FIG. 6, if a part of the wheel 160 is pressed (represented by an arrow), the wheel 160 may tilt in one direction from a horizontal state. Here, the sheet 320 and the insertion portion 262, which remain in contact when in a horizontal state, may be separated at one side (in FIG. 6, the left side) and more closely adhered at the other (in FIG. 6, the right side). The part of the sheet 320 that is separated from the insertion portion 262 may maintain a flat shape, while the sheet 320 that is more closely adhered to the insertion portion 262 may be deformed. As such, the wheel 160 can be tilted, so that a securing member protrusion 188 may press a side button 224.

Thus, the sheet 320 can be made of a flexible material, which maintains a flat state when there is no external force applied, and which changes shape when there is an external force applied. In order to reduce the friction on the sheet 320, so that the wheel 160 may rotate smoothly, the sheet 320 can be made of a material having a smooth surface. Examples of such a material may include, but are not limited to, Teflon and polyethylene terephthalate (PET), etc.

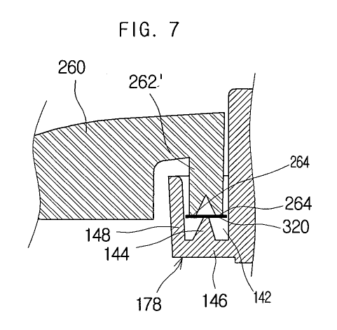

FIG. 7 is a partial cross-sectional view illustrating the composition of a flange portion 178 and an insertion portion 262′ in a rotary input apparatus according to another embodiment of the present invention. With regards the example shown in FIG. 7, the composition of the flange portion 178 can be substantially the same as that described with reference to FIG. 1, and thus will not be described in further detail.

Referring to FIG. 7, the insertion portion 262′ may touch the sheet 320 at two points of contact 264. Therefore, a foreign substance that has entered through gap A can be obstructed in movement by the two contact points 264, and can be stopped from infiltrating the interior of the rotary input apparatus 100. The insertion portion 262′ according to this embodiment can have a shape corresponding to that of the protrusion 144. Thus, when the wheel 160 is tilted and the shape of the sheet 320 is changed, the insertion portion 262′ and the protrusion 144 may be intermesh with each other and stop the movement of foreign substances.

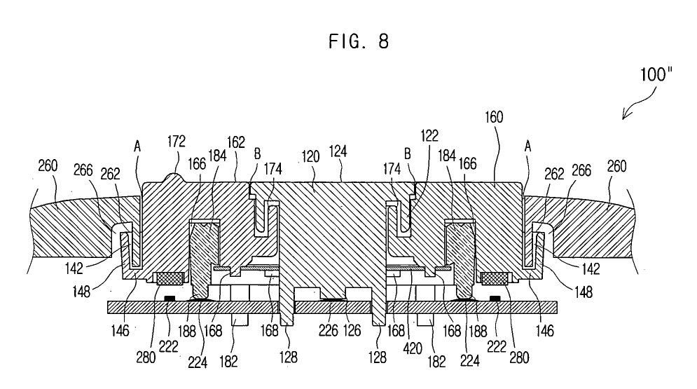

FIG. 8 is a cross-sectional view of a rotary input apparatus according to another aspect of the present invention.

Referring to FIG. 8, a rotary input apparatus 100″ according to this aspect of the invention can be substantially the same as or can be in correspondence with the composition of the rotary input apparatus 100 described above with reference to FIG. 1, except for the compositions of the insertion portion 262 of the cover 260 and the flange portion 178 of the wheel 160. As such, the following description will focus more on the differences in the two.

The cover 260 may have a center hole, which is not rendered a separate reference numeral in FIG. 8, because the wheel 160 is exposed to the exterior through the center hole. An insertion portion 262 protruding downwards may be formed on the inner perimeter of the center hole. The insertion portion 262, as illustrated in FIG. 8, may extend a particular length and protrude downwards, to be positioned within the holding groove 142 of the flange portion 178. However, the end of the insertion portion 262 may not always be in contact with the horizontal portion 146 of the flange portion 178. One reason for this can be to provide space for the movement of the wheel 160, when a part of the wheel 160 is pressed such that the wheel 160 is tilted and a side button 224 is pressed.

The composition of the flange portion 178, including a horizontal portion 146 protruding from a periphery of the wheel 160 and a vertical portion 148 protruding from the end of the horizontal portion 142, is similar to that described with reference to FIG. 1. However, the rotary input apparatus 100″ according to this aspect of the invention may not include the protrusion 144 (FIG. 1) and the sheet 320 (FIG. 1). As illustrated in FIG. 8, the insertion portion 262 can be positioned with a certain gap from the inner surface of the holding groove 142.

If a foreign substance enters from the exterior, it may move to the inside of the holding groove 142 through gap A illustrated in FIG. 8, but the movement of the foreign substance may be obstructed by the insertion portion 262. Also, the foreign substance that passes through the gap between the insertion portion 262 and horizontal portion 146 may be obstructed once more by the vertical portion 148 of the flange portion 178, making it difficult for the foreign substance to infiltrate into the circuit board 220, etc., of the rotary input apparatus 100″.

As set forth above, certain aspects of the invention can provide a rotary input apparatus capable of stopping foreign substances from infiltrating the interior.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A rotary input apparatus comprising:
a wheel;
a cover having a center hole exposing the wheel to the exterior; and
a sheet interposed between the wheel and the cover,
wherein the wheel comprises a flange portion on a periphery of the wheel, the flange portion having a holding groove formed therein and having a protrusion protruding upwards,
and wherein the cover comprises an insertion portion formed on a periphery of the center hole, the insertion portion protruding downwards and placed in the holding groove,
and wherein the sheet is in contact with each of the protrusion and the insertion portion.

2. The rotary input apparatus of claim 1, wherein the flange portion comprises a horizontal portion protruding horizontally from the periphery of the wheel and a vertical portion protruding from one end of the horizontal portion,
and the horizontal portion and the vertical portion form the holding groove.

3. The rotary input apparatus of claim 2, wherein the protrusion is formed on the horizontal portion.

4. The rotary input apparatus of claim 1, wherein the protrusion has a triangular cross section.

5. The rotary input apparatus of claim 1, wherein the insertion portion comprises a contact portion contacting the sheet,
the contact portion formed in a more outward position than the protrusion from a middle of the center hole.

6. The rotary input apparatus of claim 1, wherein the sheet is flexible.

7. The rotary input apparatus of claim 6, wherein the sheet is formed from one of Teflon and polyethylene terephthalate.

8. The rotary input apparatus of claim 2, wherein the cover comprises a circular guide groove,
and the vertical portion has a part thereof positioned in the guide groove.

9. The rotary input apparatus of claim 1, wherein the wheel comprises a through-hole formed in a center thereof, the through-hole having a ring-shaped protruding portion formed on an inner perimeter thereof,
and the through-hole has a center key inserted therein, the center key having a detent portion inserted onto the ring-shaped protruding portion.

10. The rotary input apparatus of claim 9, wherein the center key comprises a securing protrusion protruding downwards,
and the securing protrusion is inserted into a circuit board.

11. The rotary input apparatus of claim 10, wherein the center key comprises a center protrusion protruding downwards,
and the center protrusion is configured to press a center button equipped on the circuit board.

12. The rotary input apparatus of claim 1, wherein the wheel comprises an insertion cavity formed therein,
and the insertion cavity has a wheel securing member inserted therein, the wheel securing member secured to a circuit board.

13. The rotary input apparatus of claim 12, wherein the wheel securing member comprises an insertion portion inserted into the insertion cavity and a wheel securing protrusion secured to the circuit board.

14. The rotary input apparatus of claim 13, wherein the insertion portion comprises a securing member protrusion protruding downwards,
and the securing member protrusion is configured to press a side button formed on the circuit board.

15. The rotary input apparatus of claim 12, wherein the wheel comprises a plurality of detent protrusions protruding downwards,
and the detent protrusions are inserted through a washer,
and wherein the washer is caught on the wheel securing member.

16. A rotary input apparatus comprising:
a wheel; and
a cover having a center hole exposing the wheel to the exterior,
wherein the wheel comprises a flange portion formed on a periphery of the wheel, the flange portion having a holding groove formed therein,
and wherein the cover comprises an insertion portion formed on a periphery of the center hole, the insertion portion protruding downwards and placed in the holding groove,
and wherein the insertion portion is positioned with a predetermined gap from an inner surface of the holding groove.

17. The rotary input apparatus of claim 16, wherein the flange portion comprises a horizontal portion protruding horizontally from the periphery of the wheel and a vertical portion protruding from one end of the horizontal portion,
and the horizontal portion and the vertical portion form the holding groove.

18. The rotary input apparatus of claim 16, wherein the wheel comprises a through-hole formed in a center thereof, the through-hole having a ring-shaped protruding portion formed on an inner perimeter thereof,
and the through-hole has a center key inserted therein, the center key having a detent portion inserted onto the ring-shaped protruding portion.

19. The rotary input apparatus of claim 18, wherein the center key comprises a securing protrusion protruding downwards,
and the securing protrusion is inserted into a circuit board.

20. The rotary input apparatus of claim 19, wherein the center key comprises a center protrusion protruding downwards,
and the center protrusion is configured to press a center button equipped on the circuit board.

21. The rotary input apparatus of claim 16, wherein the wheel comprises an insertion cavity formed therein,
and the insertion cavity has a wheel securing member inserted therein, the wheel securing member secured to a circuit board.

22. The rotary input apparatus of claim 21, wherein the wheel securing member comprises an insertion portion inserted into the insertion cavity and a wheel securing protrusion secured to the circuit board.

23. The rotary input apparatus of claim 22, wherein the insertion portion comprises a securing member protrusion protruding downwards,
and the securing member protrusion is configured to press a side button formed on the circuit board.

24. The rotary input apparatus of claim 23, wherein the wheel comprises a plurality of detent protrusions protruding downwards,
and the detent protrusions are inserted through a washer,
and wherein the washer is caught on the wheel securing member.
